(19) United States
(12) Patent Application Publication
(10) Pub. No.: US 2012/0017658 A1
(43) Pub. Date: Jan. 26, 2012

(54) PRODUCTION OF FERTILIZER USING BIOMASS

(76) Inventor: Philip D. Leveson, Sandy Springs, GA (US)

(21) Appl. No.: 13/008,878

(22) Filed: Jan. 18, 2011

Related U.S. Application Data
(60) Provisional application No. 61/296,130, filed on Jan. 19, 2010.

(51) Int. Cl. C05C 9/00; C05C 3/00; C05C 1/00; B01J 8/00

(52) U.S. Cl. 71/28; 422/148; 71/61; 71/32

(57) ABSTRACT

Biomass is preferably first prepared so as to produce the desired size, shape and moisture content. The prepared biomass is introduced along with a gasifying oxidant into a suitable gasification device to produce syngas. A mixture of air and steam may be used as the gasifying oxidant. The syngas is purified to remove particulate matter, ash, aerosols, halogens, sulphur containing compounds and volatile organometallics. The ash produced from the gasifier is collected for later use. The purified syngas is passed through a water gas shift reactor and any carbon monoxide or carbon dioxide are removed from the syngas. The gas is then passed through an ammonia synthesis reactor. The resulting ammonia is then converted into a desired ammonia product. Finally, the ammonia product and the previously removed ash are then mixed to produce a fertilizer.

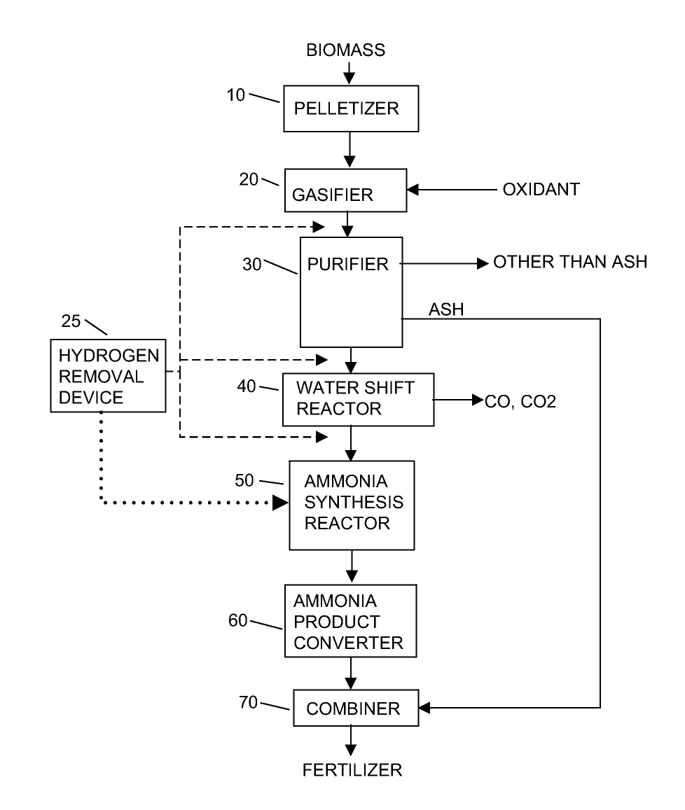

### PRIORITY CLAIM

This application claims the priority of U.S. Provisional Patent Application Ser. No. 61/296,130, filed Jan. 19, 2010, entitled “Production Of Fertilizer Using Biomass”.

### FIELD OF THE INVENTION

The present invention relates to a method of producing a fertilizer, containing nitrogen, phosphorus and potassium from a biomass feedstock.

### BACKGROUND OF THE INVENTION

During the growth cycle of biomass, certain nutrients, such as nitrogen (N), phosphorus (P) and potassium (K), are depleted from the soil. The use of fertilizers to supplement or replace these nutrients has become common and has greatly improved the yield of food crops or biomass per area of land. The increased yield can only be sustained, however, if these nutrients are continuously replenished. Typically, phosphorus and potassium are added from ores, e.g., phosphorus is sometimes added through the application of apatite, and potassium is supplemented through the application of sylvinite. Nitrogen may be added through the application of nitrates or, more commonly, through the direct application of ammonia or ammonia-derived products, such as urea pellets. These farming practices are not sustainable, however, as they deplete mineral reserves of phosphorous and potassium and/or require significant amounts of energy, such as from fossil fuels, for the mining of phosphorous and potassium and for the production of ammonia. The activities associated with the mining of minerals and the production of ammonia both result in significant carbon dioxide emissions and can cause other negative environmental effects as well.

### SUMMARY OF THE INVENTION

The present invention provides a method of producing fertilizer from biomass. Preferably, this is achieved by processing the biomass to have at least one of a desired size, shape, or moisture content; gasifying the prepared biomass with a gasifying oxidant to produce syngas; purifying the syngas by separating substantially all of the ash from the syngas; removing substantially all of the carbon monoxide and carbon dioxide from the purified syngas; converting the resulting syngas into ammonia; converting the ammonia into a desired ammonia product; and mixing at least some of the ammonia product with at least some of the separated ash to produce a fertilizer.

The present invention also provides an apparatus for producing fertilizer from biomass. The apparatus preferably includes a device to process the biomass to have at least one of a desired size, shape, or moisture content; a gasifier to gasify the processed biomass with a gasifying oxidant to produce syngas; a purifier to separate substantially all of the ash from the syngas to produce purified syngas; a cleaner to remove substantially all of the carbon monoxide and carbon dioxide from the purified syngas to produce cleaned syngas; a converter to convert the cleaned syngas into ammonia; a reactor to convert the ammonia into a desired ammonia product; and a mixer to mix the ammonia product with at least some of the separated ash to produce a fertilizer.

### BRIEF DESCRIPTION OF THE DRAWING

The FIGURE is a schematic block diagram of an exemplary system in accordance with the present invention.

### DETAILED DESCRIPTION OF THE INVENTION

As discussed herein, biomass is converted into a fertilizer with a significant N-P-K value. Biomass includes all solids derived from plant matter as well as organic municipal waste, which may contain solids and semi-solids (e.g., fats) derived from both animal matter and plant matter. The biomass is typically of relatively recent origin, but may come in many different forms. Woody forms of biomass include, for example, forest products and products or wastes derived from wood, including, for example, sawdust, paper and cardboard products. Non-woody forms of biomass include, for example, animal wastes, decomposable municipal waste, food production waste, and energy crops. The physical forms, characteristics, and typical associated moisture contents of the biomasses described above are vastly different but, on a dry ash free basis, the chemical composition and calorific value of these different biomasses are similar. Almost all biomass has a similar ratio of carbon to hydrogen to oxygen, which is summarized as CH_{1.4}O_{0.6}.

Preferably, the first stage of the process consists of gasifying the biomass into syngas. Gasification processes convert carbon-containing solids or liquids into combustible gases that ideally contain all the energy originally present in the biomass feedstock. In reality this is not easily achieved, although with good thermal management it is possible to obtain energy efficiencies in excess of 80%. The stoiciometric gasification equation is shown below:

CH_{1.4}O_{0.6}+0.2O₂→CO+0.7H₂ (1)

An energy analysis of this equation reveals that the reaction products contain more energy than the reactants, so energy must be added to implement this process. Although the additional energy needed may be provided by many different methods, such as separately burning some of the biomass, the preferred method is to burn some of the biomass as part of the process itself

If this is done in a controlled (oxygen-limited) environment then a more realistic gasification process may be represented as:

CH_{1.4}O_{0.6}+0.4O₂→0.7CO+0.6H₂+0.3CO₂+0.1H₂O (2)

In one embodiment, air is used as the oxidant in the controlled environment so the process becomes:

CH_{1.4}O_{0.6}+0.4O₂+1.6N2→0.7CO+0.6H₂+0.3CO₂+0.1H₂O+1.6N₂ (3)

In another embodiment, a mixture of air and steam is used as the gasifying oxidant.

The resulting syngas is then purified and filtered to remove any inherent or produced particles, ash, tar aerosols, sulphur, halogen and metal-containing contaminants. A number of conventional scrubbing and filtrations systems are available for cleaning operations. Typical processes and devices used to clean the syngas are hot ceramic filtration, cyclones, microcyclones, venturi scrubbers, jet venturi scrubbers, electrostatic precipitators (ESP), wet ESPs, and candle filters. These processes and devices can be used singularly or in combination. Also, caustic scrubbing can be used if the syngas contains an acid gas (HCl, H₂S, etc.). The cleaned syngas is then preferably cooled to condense out the water fraction.

The purified gas stream is then passed to a water gas shift reactor in which the carbon monoxide is used to reduce water into hydrogen. This may be the same water that was previously condensed out of the syngas or, if the cooling process is carefully controlled, may be the water still contained in the syngas. The reaction can be summarized as:

0.7CO+0.6H₂+0.3CO₂+1.6N₂+0.7H₂O→1.3H₂+1.0CO₂+1.6N₂ (4)

A number of commercial water-gas shift catalysts are available to promote the above reaction. It should be noted that some catalysts are slower than others, and some catalysts are highly toxic to humans and to the environment. Preferably, but not necessarily, the overall water-gas shift reaction is performed in two stages: a first high temperature stage (temperature in the range of 300 degrees to 550° C., and preferably around 400° C.) which allows rapid kinetics, and a second lower-temperature stage (temperature in the range of 100 to 250° C., and preferably around 200° C.) which allows a highly converted equilibrium to be attained. The carbon dioxide is then removed from the gas stream using known techniques such as pressure swing adsorption, scrubbing techniques, or using MEA (monoethanolamine) as a solvent.

The next purification step involves passing the stream over a hydrogenation catalyst such that any unreacted carbon monoxide and carbon dioxide are hydrogenated to produce methane, which may then removed from the gas stream.

The remaining stream, being now primarily a mixture of hydrogen and nitrogen is compressed and passed over a further catalyst to produce the ammonia. The reaction is summarized as:

1.3H₂+1.6N₂→0.86NH₃+1.17N₂ (5)

The ammonia may then be converted into an ammonia product, such as NH₄OH (ammonium hydroxide) or NH₄NO₃ (ammonium nitrate), or even CO(NH₂)₂ (urea).

A co-product of the gasification process is the “ash” mentioned above. The ash contains essentially all of the non-volatile components inherent within the biomass. These components include significant fractions of potassium, phosphorus, calcium, iron and magnesium. The quantities of each of these components is highly dependant upon the feedstock utilized but, as an example, if a hard wood is utilized as feedstock then potassium oxide may account for around fifteen percent by weight of the ash whilst phosphorus pentoxide may be around eight percent by weight.

The ammonia product and the ash can then be combined to produce a fertilizer. The fertilizer can be applied to farm land as a fertilizer to promote the N-P-K value of the land and allow high crop productivity to be achieved in a sustainable manner. If the ammonia product is in the form of ammonium hydroxide then it may be combined with the ash to produce a slurry which can be, for example, sprayed onto the farmland. If the ammonia product is in the form of ammonium nitrate or urea then it may be mixed with the ash to produce pellets (or other desired shapes) which then can then be spread over the farmland. The relative portions of the ammonia product and the ash can be adjusted, if desired, to adjust the NPK value of the fertilizer. For example, more ammonia product, relative to the amount of ash, results in a higher N value for the fertilizer product. Conversely, less ammonia product, relative to the amount of ash, results in higher PK values for the fertilizer product.

Turning now to the FIGURE, which is a schematic block diagram of an exemplary system in accordance with the present invention, the biomass is preferably first prepared so as to produce the desired size, shape and moisture content, such as by a pelletizer (10). The prepared biomass is introduced along with a gasifying oxidant into a suitable gasification device (20) to produce syngas.

The syngas is purified (30) to remove particulate matter, ash, aerosols, halogens, sulphur containing compounds and volatile organometallics. The ash produced from the gasifier is collected for later use. The purified syngas is passed through a water-gas shift reactor (40) to remove any carbon monoxide or carbon dioxide from the syngas. The gas is then passed through an ammonia synthesis reactor (50). The resulting ammonia is then converted (60) into a desired ammonia product. The ammonia product and the previously collected ash are then combined (70) to produce the desired fertilizer. applied to farmland as an NPK fertilizer to enhance the NPK value of the farmland.

A hydrogen removal device (25) may also be used to separate hydrogen from the syngas. Such devices include hydrogen selective membranes, high permeability membranes, and pressure swing absorption type devices. The hydrogen is removed from the syngas such that a number of later purification steps may be avoided. The hydrogen may be removed prior to or after the purification and water gas shift unit operations. If the hydrogen is removed prior to the water gas shift reactor the remaining syngas will still contain a significant energy content and may be used as a fuel to a boiler, internal combustion engine or other fuel-requiring process. After the hydrogen is separated it may be combined with nitrogen and fed into the Ammonia Synthesis Reactor (50). The optional hydrogen removal device may be inserted at the various points indicated by the dashed lines, and the hydrogen output is shown by the dotted line. The use of the device allows for better control of the relative proportions of the hydrogen and nitrogen fed into the Ammonia Synthesis Reactor.

The present invention enhances the quality of the environment by reducing the quantity of material going to landfills, reduces green house gas emission by using materials that might otherwise simply be burned, and conserves energy resources by providing a useful product, fertilizer, from materials that might otherwise be simply burned or tossed into a landfill to dispose of them.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of this disclosure.

1. A method of producing fertilizer from biomass, comprising:
processing the biomass to have at least one of a desired size, shape, or moisture content;
gasifying the prepared biomass with a gasifying oxidant to produce syngas;
purifying the syngas by separating substantially all of the ash from the syngas;
removing substantially all of the carbon monoxide and carbon dioxide from the purified syngas;
converting the resulting syngas into ammonia;
converting the ammonia into a desired ammonia product; and
mixing at least some of the ammonia product with at least some of the separated ash to produce a fertilizer.

2. The method of claim 1 wherein the gasifying oxidant is a mixture of air and steam.

3. The method of claim 1 wherein the ammonia is converted into one of ammonium hydroxide, ammonium nitrate, or urea as the desired ammonia product.

4. The method of claim 1 wherein at least some of the biomass is burned to provide energy to gasify the prepared biomass.

5. The method of claim 1 wherein purifying the syngas also comprises removing substantially all of at least one of the following: particulate matter, aerosols, halogens, sulphur containing compounds, or volatile organometallics.

6. The method of claim 1 wherein processing the biomass is performed using a pelletizer.

7. The method of claim 1 wherein converting the resulting syngas into ammonia is performed using an ammonia synthesis reactor.

8. The method of claim 1 wherein removing substantially all of the carbon monoxide and carbon dioxide from the purified syngas is performed using a water-gas shift reactor.

9. The method of claim 1 and further comprising adjusting the relative amounts of the ammonia product and the ash to achieve the desired nitrogen-phosphorous-potassium (NPK) value for the fertilizer.

10. The method of claim 1 wherein hydrogen is removed from the syngas after said gasifying but before said converting into ammonia, and wherein the removed hydrogen is used with said resulting syngas to produce ammonia.

11. An apparatus for producing fertilizer from biomass, comprising:
a device to process the biomass to have at least one of a desired size, shape, or moisture content;
a gasifier to gasify the processed biomass with a gasifying oxidant to produce syngas;
a purifier to separate substantially all of the ash from the syngas to produce purified syngas;
a cleaner to remove substantially all of the carbon monoxide and carbon dioxide from the purified syngas to produce cleaned syngas;
a converter to convert the cleaned syngas into ammonia;
a reactor to convert the ammonia into a desired ammonia product; and
a mixer to mix the ammonia product with at least some of the separated ash to produce a fertilizer.

12. The apparatus of claim 11 wherein the gasifying oxidant is a mixture of air and steam.

13. The apparatus of claim 11 wherein the reactor converts at least some of the ammonia into at least one of one of ammonium hydroxide, ammonium nitrate, or urea, as the desired ammonia product.

14. The apparatus of claim 11 wherein the gasifier burns at least some of the biomass to provide energy for gasification.

15. The apparatus of claim 11 wherein the purifier also removes substantially all of at least one of the following: particulate matter, aerosols, halogens, sulphur containing compounds, or volatile organometallics.

16. The apparatus of claim 11 wherein the device to process the biomass is a pelletizer.

17. The apparatus of claim 11 wherein the reactor is an ammonia synthesis reactor.

18. The apparatus of claim 11 wherein the cleaner is a water-gas shift reactor.

19. The apparatus of claim 11 wherein the mixer also adjusts the relative amounts of the ammonia product and the ash to achieve a desired nitrogen-phosphorous-potassium (NPK) value for the fertilizer.

20. The apparatus of claim 11 and further comprising a hydrogen removal device to separate hydrogen from the syngas after said gasifier but before said converter, and wherein the converter is an ammonia synthesis reactor which converts the cleaned syngas and separated hydrogen into ammonia.
